(19) United States
(12) Patent Application Publication
(10) Pub. No.: US 2025/0378007 A1
(43) Pub. Date: Dec. 11, 2025

(54) MULTI-AGENT WORKFLOWS FOR RESOLVING CODING COMPLICATIONS VIA GENERATIVE AI INTEGRATIONS

(71) Applicant: Microsoft Technology Licensing, LLC, Redmond, WA (US)

(72) Inventors: Sumit GULWANI, Sammamish, WA (US); Dustin Joseph COLEMAN, Ravensdale, WA (US); Yasharth BAJPAI, Lucknow (IN); Gustavo Araujo SOARES, Seattle, WA (US); Cagri ASLAN, Newcastle, WA (US); Arjun RADHAKRISHNA, Redmond, WA (US); Bhavya CHOPRA, Bengaluru (IN); Param Hemant Kumar BIYANI, Mumbai (IN); Christopher Joseph PARNIN, Raleigh, NC (US)

(21) Appl. No.: 18/737,272

(22) Filed: Jun. 7, 2024

(51) Int. Cl. G06F 11/36; H04L 51/02

(52) U.S. Cl. CPC G06F 11/362; H04L 51/02

(57) ABSTRACT

Systems, methods, and software are disclosed herein for resolving coding issues via generative AI integrations in various implementations. In an implementation, in a debugging session, a computing apparatus receives a user query relating to an exception in source code. The computing apparatus elicits a response from a generative AI model which is tasked with identifying an interaction pattern for resolving the user query. The computing apparatus mediates the debugging session according to the interaction pattern identified by the generative AI model.

### TECHNICAL FIELD

Aspects of the disclosure are related to the field of software development environments and foundation model integrations for coding tasks.

### BACKGROUND

In software development, debugging code is a common task which involves localizing and understanding the error before the error can be resolved. Coders who use integrated development environments (IDEs) for software development have a wealth of debugging-related tools to assist with debugging tasks such as syntax highlighting, breakpoints, and step-through execution. In some cases, the IDE will also provide information about the exception to assist with resolution, such as symptoms of the bug and common causes of such bugs. Using these tools, the user's task of ferreting out and resolving the issue can be expedited.

An emergent capability of generative artificial intelligence (AI) models is the ability to understand code, including generating code and debugging code. This ability arises from a number of strengths of such models: pattern recognition, syntax and semantic analysis, contextual understanding, and continuous learning. For example, a user can provide a model with a portion of the code throwing an exception, and the model will return a description of the problem and replacement code to resolve the issue. This is particularly effective when the bug is a simple one (e.g., a typo or an incorrect function call). But as is often the case, the source of the issue may be buried deep in the code and be somewhat distant from the portion of the code where the exception is flagged. Resolving such complications can involve a fair amount of detective work including identifying potential culprits and eliminating the suspects one by one.

To prompt a generative AI model to resolve more difficult coding issues, the user can provide lengthier portions of the source code, but the problem with this approach is that providing too much information, including information which may be irrelevant to the issue, runs the risk of overwhelming the model. For example, providing the entire source code of a large software application when the issue lies within a specific function can dilute the focus of the AI model. This may cause the model to digress-to lose its focus on the problem at hand and become sidetracked by irrelevant parts of the code. Thus, the task falls to users to determine what information to feed the model to obtain useful information to resolve the issue, a process which is not very dissimilar to the process coders might employ to fix the bug themselves.

### OVERVIEW

Technology is disclosed herein for resolving coding issues via generative AI integrations in various implementations. In an implementation, in a debugging session, a computing apparatus receives a user query relating to an exception in source code. The computing apparatus elicits a response from a generative AI model which is tasked with identifying an interaction pattern for resolving the user query. The computing apparatus mediates the debugging session according to the interaction pattern identified by the generative AI model.

In an implementation, to mediate the debugging session, the computing apparatus executes a multi-agent workflow. To execute the multi-agent workflow when the interaction pattern is multi-turn, the computing apparatus calls a collaborative agent which prompts the generative AI model to host a conversational exchange between the generative AI model and the user. In an implementation, the computing apparatus calls a context retrieval agent which prompts the generative AI model to generate a script by which to retrieve contextual information for prompts to host the conversational exchange between the generative AI model and the user.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment for a multi-agent process for resolving coding complications in an implementation.

FIG. 2 illustrates a process for a multi-agent process for resolving coding complications in an implementation.

FIGS. 3A and 3B illustrate workflows for a multi-agent process for resolving coding complications implementation.

FIG. 4 illustrates an operational environment for a multi-agent process for resolving coding complications in an implementation.

FIG. 5 illustrates a workflow for a multi-agent process for resolving coding complications in an implementation.

FIG. 6 illustrates a user experience for a multi-agent process for resolving coding complications in an implementation.

FIG. 7 illustrates a user experience for a multi-agent process for resolving coding complications in an implementation.

FIGS. 8A and 8B illustrate elements of a multi-agent process for resolving coding complications in an implementation.

FIG. 9 illustrates a computing system suitable for implementing the various operational environments, architectures, processes, scenarios, and sequences discussed below with respect to the other Figures.

### DETAILED DESCRIPTION

Various implementations of systems and methods are disclosed herein for multi-agent workflows for resolving coding issues, e.g., debugging code, in software development environments. In an implementation, a user executes source code in an integrated development environment (IDE) such as Microsoft Visual Studio IDE. An exception is thrown indicating a bug (i.e., an issue, error, or complication) or other unexpected or undesirable behavior in the code. The user enters a query about the bug in an application assistant of the IDE, for example, by keying in a natural language query in a chat pane of the application assistant. Upon receiving the user query, the application assistant initiates a multi-agent workflow to debug the code. The multi-agent workflow deploys software-defined agents in an orchestrated interaction to debug the code. In implementations of the multi-agent workflow, each of the agents performs a specific task which advances the workflow by eliciting AI-generated output to resolve the user query (i.e., to resolve the bug), to obtain additional information from the user toward resolving the user query, to provoke an action by another agent, to obtain contextual information from the IDE for identifying or localizing the bug, to suggest inputs that the user may select in relation to the debugging process, and so on. The interaction may be coordinated by an orchestration layer of the application assistant which deploys agents to perform the various steps of the workflow, such as interaction with the user or context retrieval, and which executes functions in which the generative AI model is prompted to decide the next step to be performed or agent to be deployed.

When the workflow executes, the user query is classified by a classification function according to an interaction pattern which identifies the next agent in the workflow. The interaction patterns which may be selected by the classification function include a single-shot response pattern and a multi-turn interaction pattern. For example, if the classification function determines that the user query can be adequately resolved with a single, close-ended response, the classification function returns an indication to the orchestration layer to forward the user query to a responder or single-shot agent. In contrast, should the classification function determine that responding to the user query requires additional information (e.g., information from the user or contextual information about the source code), the classification function returns an indication to the orchestration layer to forward the user query to a collaborative agent for a multi-turn interaction with the user. In an implementation, the classification function receives the user query as input and prompts the generative AI model to select an agent from a list of available agents and descriptions of their corresponding interaction patterns. In response to the prompt, the generative AI model identifies the agent corresponding to the best or most appropriate interaction pattern for resolving the user query from the list. Based on the response, the workflow advances to the selected agent.

When the workflow advances to a collaborative agent, the collaborative agent engages in a multi-turn interaction or dialog with the user to resolve the coding issue. The collaborative agent may attempt to identify and localize the root cause of the issue by asking the user questions about the source code and its execution. For example, the collaborative agent may inquire as to the value of a local variable at some point in the execution or suggest the user perform an action (e.g., install a breakpoint, perform a hot reload) and report the results from that action. Thus, the bug can be identified, localized, and resolved in a collaborative manner, with the collaborative agent probing the user for specifics about the issue.

In addition to sorting out an issue through collaborative dialog with the user, in some scenarios, the multi-agent workflow includes a context retrieval agent which captures contextual information relating to the source code from the IDE hosting the source code, such as exception information, local state information, and stack information. Via an application programming interface (API) of the IDE, the context retrieval agent accesses exception information including the exception message, the exception type, stack traces, and the location in the source code where the exception is thrown. Local state information captured by the context retrieval agent can include selections of code (e.g., code snippets) and local variable values and context. Stack information obtained by the context retrieval agent can include logical code snippets from the current stack and the corresponding active line at the exception time. Information captured by the context retrieval agent may be appended to a chat history or internal messaging history for the multi-agent workflow which is used to provide context for prompts to the generative AI model from the various agents.

The multi-agent workflow may also include a follow-up agent to suggest natural language inputs relating to the debugging process that the user can select to obtain more information, to respond to questions posed by application assistant during a collaborative exchange, etc. For example, a suggested user input may be the likely response to a question posed by the collaborative agent. A suggested user input may also be a question the user would have about how to determine a value of a local variable during execution. A suggested user input may also be an action (e.g., in the form of a hyperlink) that the user may want to take in the process of debugging the code, such as causing the IDE to insert a breakpoint at a location suggested by the collaborative agent.

As the workflow progresses, the application assistant maintains a chat history or record of content produced by the various agents along with inputs provided by the user (e.g., responses to questions posed by the collaborative agent). The chat history provides contextual information for prompts from the agents to the generative AI model(s) in generating output for the agents and functions. In some cases, to ensure that prompts to the generative AI model do not exceed a token limit, the chat history may be pruned by selectively retaining important messages such as the initial user query, retrieved exception context, and initial response. The history may also be pruned by prompting an AI model to briefly summarize the messages in the conversation up to this point and using the summary instead of the full chat history. Similarly, contextual information captured by the context agent may be limited, e.g., in terms of the number of stack frames included in the prompts.

In various implementations, multi-agent workflows for collaborative debugging include a coordinated interaction of software agents driven by generative artificial intelligence (AI) and managed in their interactions by an orchestration layer. The agents are empowered to communicate with each other and to act in response to other agents. The interaction may incorporate user input and may be augmented by contextual information to ensure the interaction remains focused on accomplishing the task at hand. The agents may be defined as instances of a ConversableAgent of an AutoGen application or other agent-enabling framework, such as MetaGPT. The ConversableAgent object may include attributes such as a name or identifier by which the object is called, a definition of the agent's role, and an identifier for the generative AI model which animates the agent. An interaction between various agents may be initiated by the application assistant receiving a user query relating to a coding complication. The multi-agent workflow may be implemented in programming languages such as Python, JavaScript, C/++, Java, and so on.

Generative AI models of the technology disclosed herein include large-scale foundation models trained on massive quantities of diverse, unlabeled data using self-supervised, semi-supervised, or unsupervised learning techniques. Such models may be based on a number of different architectures, such as generative adversarial networks (GANs), variational auto-encoders (VAEs), and transformer models, including multimodal transformer models. Foundation models capture general knowledge, semantic representations, and patterns and regularities in or from the data, making them capable of performing a wide range of downstream tasks. Foundation models include BERT (Bidirectional Encoder Representations from Transformers) and ResNet (Residual Neural Network). In some scenarios, a foundation model may be fine-tuned for specific downstream tasks. Fine-tuning a foundation model involves adjusting the parameters of the pretrained model according to a specific dataset to adapt the model's output to a particular task. Types of foundation models may be broadly classified as or include pre-trained models, base models, and knowledge models, depending on the particular characteristics or usage of the model. To prompt a generative AI model or to elicit output (e.g., AI-generated content) from a generative AI model, input is submitted to the model which causes the model to generate its output according to instructions provided in the input and according to its training. Foundation models may be multimodal or unimodal depending on the modality of the inputs.

Multimodal models are a class of foundation model which extend their pre-trained knowledge and representation capabilities to handle multimodal data, such as text, image, video, and audio data. Multimodal models may leverage techniques like attention mechanisms and shared encoders to fuse information from different modalities and create joint representations. Learning joint representations across different modalities enables multimodal models to generate multimodal outputs that are coherent, diverse, expressive, and contextually rich. For example, multimodal models can generate a caption or textual description of the given image by extracting visual features using an image encoder, then feeding the visual features to a language decoder to generate a descriptive caption. Similarly, multimodal models can generate an image based on a text description (or, in some scenarios, a spoken description transcribed by a speech-to-text engine). Multimodal models work in a similar fashion with video—generating a text description of the video or generating video based on a text description.

Multimodal models include visual-language foundation models, such as CLIP (Contrastive Language-Image Pre-training), ALIGN (A Large-scale ImaGe and Noisy-text embedding), and ViLBERT (Visual-and-Language BERT), for computer vision tasks. Examples of visual multimodal or foundation models include DALL-E, DALL-E 2, Flamingo, Florence, and NOOR. Types of multimodal models may be broadly classified as or include cross-modal models, multimodal fusion models, and audio-visual models, depending on the particular characteristics or usage of the model.

Large language models (LLMs) are a type of foundation model which processes and generates natural language text. These models are trained on massive amounts of text data and learn to generate coherent and contextually relevant responses given a prompt or input text. LLMs are capable of understanding and generating sophisticated language based on their trained capacity to capture intricate patterns, semantics and contextual dependencies in textual data. In some scenarios, LLMs may incorporate additional modalities, such as combining images or audio input along with textual input to generate multimodal outputs. Types of LLMs include language generation models, language understanding models, and transformer models.

Transformer models, including transformer-type foundation models and transformer-type LLMs, are a class of deep learning models used in natural language processing (NLP). Transformer models are based on a neural network architecture which uses self-attention mechanisms to process input data and capture contextual relationships between words in a sentence or text passage. Transformer models weigh the importance of different words in a sequence, allowing them to capture long-range dependencies and relationships between words. GPT (Generative Pre-trained Transformer) models, BERT (Bidirectional Encoder Representations from Transformer) models, ERNIE (Enhanced Representation through kNowledge Integration) models, T5 (Text-to-Text Transfer Transformer), and XLNet models are types of transformer models which have been pretrained on large amounts of text data using a self-supervised learning technique called masked language modeling. Such pretraining allows the models to learn a rich representation of language that can be fine-tuned for specific NLP tasks, such as text generation, language translation, or sentiment analysis.

Technical effects of the technology disclosed herein further include faster convergence to a desirable outcome which in turn reduces compute costs (e.g., processor usage, time) as well as an improved user experience. Technical effects also include simplified software development—the software development is significantly reduced from what would be necessary for deterministic algorithms to accomplish what can be accomplished via generative AI model integrations. The use of multi-agent workflows guided by generative AI enables tremendous flexibility in responding to user queries without the constraints of deterministic coding, e.g., planning for a particular scope of coding complications, coding environments, coding applications, user queries, and other factors. Simplified software development also reduces development time and software complexity, which in turn makes the software easier to debug and to maintain.

Further, automated generative AI model prompting including automated context retrieval from the IDE enables AI-generated responses to be elicited that are highly relevant to the user query. Moreover, improving the user experience by faster issue resolution promotes user engagement and contributes to increased productivity.

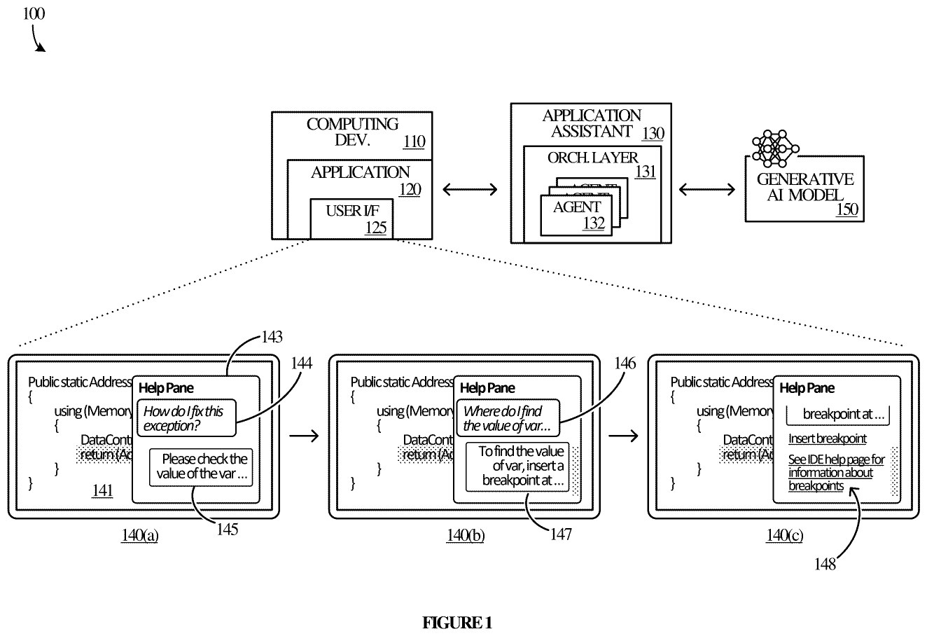

Turning now to the Figures, FIG. 1 illustrates operational environment 100 for multi-agent workflows for collaborative debugging and issue resolution in an implementation. Operational environment 100 includes computing device 110 and generative AI model 150. Computing device 110 hosts application 120 and user interface 125 of application 120. Application assistant 130 includes orchestration layer 131 and multiple agents 132 the number of which can vary with no loss of generality. User interface 125 hosts user experiences 140 shown in various stages of operation as user experiences 140(a)-(c). User experiences 140 display source code 141 in an IDE environment and chat pane 143 by which a user can interact with application assistant 130.

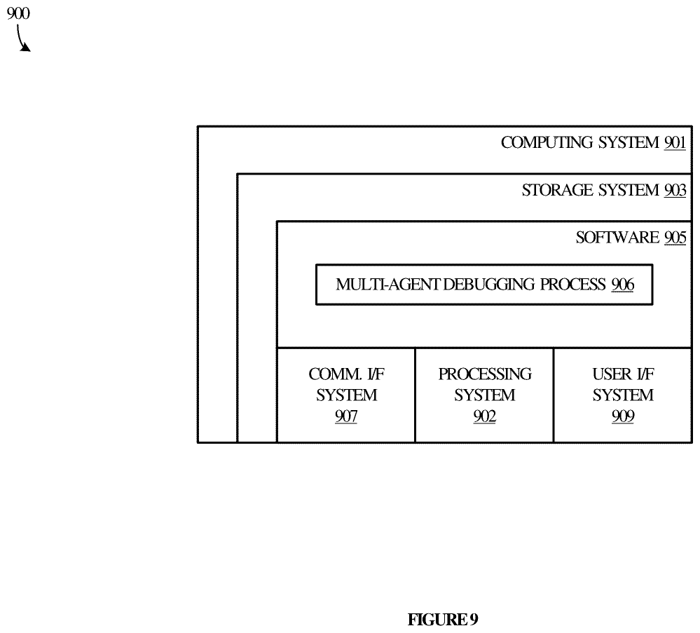

Computing device 110 is representative of a computing device, such as a laptop or desktop computer, a mobile computing device (e.g., smartphone, tablet), or a server computing device, of which computing system 901 in FIG. 9 is broadly representative. Computing device 110 communicates with other computing devices including application servers or generative AI model 150 via one or more internets and intranets, the Internet, wired or wireless networks, local area networks (LANs), wide area networks (WANs), and any other type of network or combination thereof. A user may interact with an application 120 via user interface 125 displayed on computing device 110. User experiences 140(a)-(c) displayed in user interface 125 are representative of user experiences of an environment hosted by application 120 in an implementation.

Application 120 is representative of a software application for coding and software development with which a user or an application assistant can interact to resolve coding issues, to understand the execution of the code, and the like. For example, application 120 may be an IDE, and the coding issues may be bugs, exceptions, complications, inefficiencies, etc., in source code hosted in application 120 (e.g., source code 141). Application 120 may execute locally on a user computing device, such as computing device 110, or application 120 may execute on one or more servers in communication with computing device 110 over one or more wired or wireless connections, causing user interface 125 to be displayed on computing device 110. In some scenarios, application 120 may execute in a distributed fashion, with a combination of client-side and server-side processes, services, and sub-services. For example, the core logic of application 120 may execute on a remote server system with user interface 125 displayed on a client device. In still other scenarios, computing device 110 is a server computing device, such as an application server, capable of displaying user interface 125, and application 120 executes locally with respect to computing device 110.

Application 120 executing locally with respect to computing device 110 may execute in a stand-alone manner, within the context of another application such as a presentation application or word processing application, or in some other manner entirely. In an implementation, application 120 hosted by a remote application service and running locally with respect to computing device 110 may be a natively installed and executed application, a browser-based application, a mobile application, a streamed application, or any other type of application capable of interfacing with the remote application service and providing local user experiences displayed in user interface 125 on the remote computing device.

In an implementation, computing device 110 executes application 120 locally which provides a local user experience, as illustrated by user experiences 140(a)-(c) via user interface 125. Application 120 running locally with respect to computing device 110 may be a natively installed and executed application, a browser-based application, a mobile application, a streamed application, or any other type of application capable of interfacing with generative AI model 150 and providing a user experience displayed in user interface 125 on computing device 110. Application 120 may execute in a stand-alone manner, within the context of another application, or in some other manner entirely.

Application assistant 130 is representative of a functionality (e.g., service or tool) for coordinated interaction of multiple agents, such as agents 132, which interface with a generative AI model, such as generative AI model 150, for resolving a user query relating to a coding complication. Application assistant 130 may be a service which hosts an API by which an application, such as application 120, transmits and receives task information, including output generated by generative AI model 150, or application assistant 130 may be a functionality hosted by application 120. Application assistant 130 includes orchestration layer 131 for coordinating the activities of agents 132 which perform reasoning and execution tasks. For example, orchestration layer 131 may be an AutoGen application which manages agents 132 for executing the steps of an agentic workflow for resolving coding complications. Application assistant 130 may also include repositories for storing agents 132 and/or prompt templates associated with agents 132.

Agents 132 are representative of software-defined agents for prompting generative AI models such as generative AI model 150 to generate output in relation to task management activities and task execution activities. Agents 132 can include capabilities powered by generative AI models, human input, or tools, including tools or code generated by others of agents 132. Agents 132 include prompts configured (e.g., populated) based on prompt templates each of which includes specific instructions tasking a generative AI model with generating a specific kind of output in a specific format for a specific activity. Although a single generative AI model is illustrated in FIG. 1, it may be appreciated that application assistant 130 may communicate with any number of different generative AI models with varying capabilities and competencies of which generative AI model 150 is representative. For example, a generative AI model may be selected and prompted according to the specific capabilities or competencies of the model, or a model may be trained or fine-tuned for specific tasks. Application assistant 130 may interact with a selected model based on the nature of the activity to be performed.

Generative AI model 150 is representative of a deep learning model or generative pretrained transformer (GPT) computing model or architecture, such as Dall-E, GPT-n, Claude, Gemini, Llama, or other types of deep learning architectures such as state-space models (e.g., Mamba). Generative AI model 150 is hosted by one or more computing services which provide services by which application 120 can communicate with generative AI model 150, such as an application programming interface (API). In communicating with application 120, generative AI model 150 may send and receive information (e.g., prompts and replies to prompts) in data objects, such as JavaScript Object Notation (JSON) objects. Generative AI model 150 may be implemented in the context of one or more server computers co-located or distributed across one or more data centers.

A brief operational scenario of operational environment 100 follows. A user of computing device 110 interacts with application 120 hosting source code 141 in user experiences 140(a)-(c). In user experience 140(a), an exception is thrown during the execution of source code 141. With the line of source code 141 highlighted to indicate the location where the exception occurred, the user launches chat pane 143 and enters user query 144 to resolve the exception. Application 120 sends user query 144 along with information about the exception to application assistant 130.

Upon receiving user query 144, application assistant 130 launches orchestration layer 131 which initiates a multi-agent workflow for resolving coding complications. In executing the workflow, orchestration layer 131 calls various functions and agents, at least some of which are powered or animated by generative AI model 150 to identify and localize the issue and generate a resolution to user query 144. For example, when user query 144 is received, orchestration layer 131 may call a classification function (not shown) to identify the appropriate agent of agents 132 to resolve user query 144. In calling a given agent of agents 132, application assistant 130 generates a prompt corresponding to the classification agent for submission to generative AI model 150 which includes rules or instructions by which the model is to generate its output. For the sake of illustration, it will be assumed that, in response to the prompt, generative AI model 150 identified a collaborative agent of agents 132 for performing the next step of the workflow. The collaborative agent acts as a proxy or an interface to generative AI model 150 in its interactions with the user in chat pane 143.

Orchestration layer 131 calls the collaborative agent of agents 132 to engage in a multi-turn conversation with the user via chat pane 143. Each time orchestration layer 131 calls the collaborative agent, the collaborative agent prompts generative AI model 150 to generate requests (e.g., questions, actions to be taken by the user to obtain information) to be posed to the user in pursuit of more information for resolving user query 144. In some implementations, orchestration layer 131 may be a GroupChatManager which orchestrates the interaction of agents 132 according to an AutoGen workflow for resolving coding complications. In prompting generative AI model 150, application assistant 130 generates prompts to generative AI model 150 which include the user query, contextual information about the exception (e.g., the type of error that occurred) and the portion of source code 141 where the exception occurred (e.g., a block or snippet of the code), and any preceding chat history (e.g., outputs generated by generative AI model 150 and content entered by the user in chat pane 143) since the workflow was initiated. In various implementations, contextual information obtained from application 120 for the prompts to generative AI model 150 is captured by a context retrieval agent of agents 132.

Application assistant 130 receives output from generative AI model 150 in response to the prompts including questions or other requests to advance the dialog between the collaborative agent and the user. For example, in user experience 140(a), chat pane 143 displays output 145 including a request by the collaborative agent (i.e., by generative AI model 150 via the collaborative agent) for the value of a variable which may be useful for resolving the complication. As the interchange progresses, the chat history is updated with new content contributed by the user or elicited from generative AI model 150.

Continuing in user experience 140(b), the user enters user input 146 in chat pane 143 asking where to obtain the requested information. Application assistant 130 receives user input 146 via user interface 125, and orchestration layer 131 calls the collaborative agent once again to obtain an AI-generated response from generative AI model 150, with the prompt to generative AI model 150 including the dialog in chat pane 143 up to that point. Generative AI model 150 generates output 147 received in response to user input 146 suggesting where or how the user can obtain the requested information.

The interchange continues until the collaborative agent produces a resolution to user query 144, which may include modification or add to source code 141. As illustrated in user experience 140(c), when output is obtained from generative AI model 150, the model may also be prompted to suggest user inputs 148 to display in chat pane 134 which relate to the dialog or the complication. Thus, instead of keying in an entry in chat pane 134, the user may simply select a user input of user inputs 148 to elicit a response from generative AI model 150 or to cause application 120 to perform an action (e.g., insert a breakpoint in source code 141 per output 147, surface a help page).

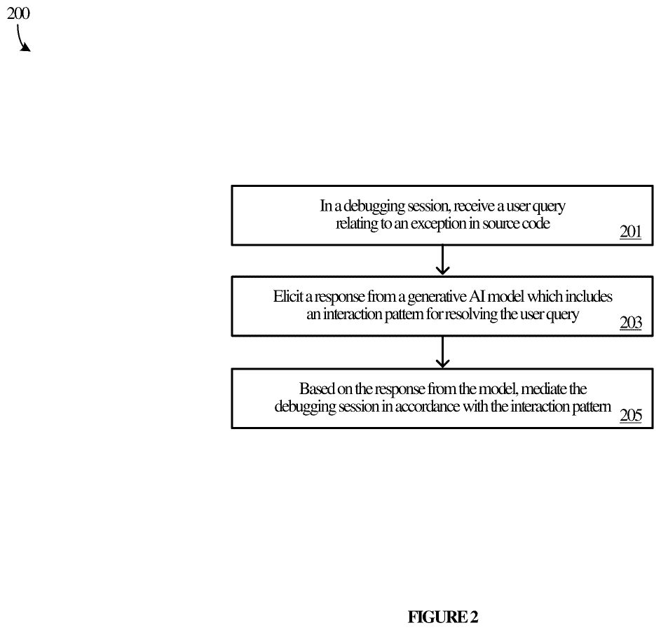

FIG. 2 illustrates a method of executing a multi-agent workflow for resolving coding complications in an implementation, herein referred to as process 200. Process 200 may be implemented in program instructions in the context of any of the software applications, modules, components, or other such elements of one or more computing devices. The program instructions direct the computing device(s) to operate as follows, referred to in the singular for the sake of clarity.

In a debugging session, the computing device receives a user query relating to an exception in source code (step 201). In an implementation, the computing device hosts a user interface for an application for editing and executing source code. The application includes or communicates with an application assistant by which users can obtain assistance with coding tasks, such as searching application help pages or querying a generative AI model for resolving coding issues (i.e., generating output the implementation of which in the source code resolves coding issues). When the source code executes, an exception is thrown indicating a bug or other unexpected or undesirable behavior in the source code. The exception may be indicated in the form of highlighted code in a display of the source code in the user interface along with an information pane providing details about the error.

To resolve the issue, the user may start an interactive session to debug the source code by launching a chat pane of the application assistant in the user interface. In the chat pane, the user may enter a natural language query about the exception, e.g., by keying in the query or speaking the query to a speech-to-text translator. In some cases, the application may suggest a natural language query for the exception which the user can accept. For example, the application may display a number of suggested actions (e.g., as hyperlinks) the user can take to resolve the query, including obtaining assistance from the application assistant, surfacing a help page about the type of exception that was thrown, and so on. In various implementations, when the user submits the query, contextual information about the exception, including relevant portions of the source code, the execution threads or processes, values of variables, and so on are provided with the user query to the application assistant for context in providing a response.

In an implementation, when the user submits the user query relating to the exception, the application assistant executes a multi-agent workflow for resolving the query or the exception. To execute the multi-agent workflow, the application assistant prompts a generative AI model with generating output by which to advance the workflow toward resolving the query. The output may be generated by the model in the course of performing functions which determine a next step in the workflow or responding to prompts corresponding to software-defined agents which direct the model to accomplish a particular task, such as generating questions which probe the source code or its execution to resolve a coding issue.

In some cases, an action by the user will trigger execution of the multi-agent workflow. For example, when the user causes the application assistant pane to be launched or when the user clicks a “Help” button in association with an exception raised in the application, the application assistant may execute the multi-agent workflow to initiate an interaction, such as a conversational exchange or a single-shot question-answer interaction for resolving the issue.

The computing device elicits a response from a generative AI model which includes an interaction pattern for resolving the user query (step 203). In an implementation, the application assistant prompts the generative AI model to classify the user query as one which can be fully resolved by a single response corresponding to a single-shot interaction pattern or one which requires further investigation corresponding to a multi-turn interaction pattern. For example, the application assistant may execute a classification function which prompts the generative AI model to identify an interaction pattern for resolving the user query from a list of possible interaction patterns. The model returns a selected interaction pattern by which the application assistant will address the user query.

Based on the response from the generative AI model, the computing device mediates the debugging session in accordance with the interaction pattern (step 205). For example, if the query is one which can be resolved in a single response, the model may be further tasked with generating the response which the application assistant displays in the user interface. On the other hand, if the query is one which requires further investigation to resolve the complication, the application assistant prompts the model to generate questions or other requests to be presented to the user to obtain more information about the exception. As the user submits responses to the requests from the model, the application assistant maintains a chat history or messaging record of the conversational exchange between the user and the generative AI model which provides context for the model to continue participating in the dialog.

In various implementations, the application assistant terminates the workflow for resolving the exception based on an indication from the user that the exception has been resolved (e.g., in a message entered by the user in the chat pane) or when the source code is executed and the exception no longer occurs.

Referring again to FIG. 1, operational environment 100 includes a brief example of process 200 as employed by elements of operational environment 100 in an implementation. Computing device 110 executes application 120 including causing local user experiences 140(a)-(c) to be displayed in user interface 125. Application 120 may execute locally with respect to computing device 110, or computing device 110 may host application 120 which executes on one or more server computing devices remote from and in communication with computing device 110, or application 120 may execute in distributed, client-server fashion. Application 120 calls application assistant 130 to execute elements of process 200 for resolving coding complications. User experiences 140(a)-(c) may include a graphical dashboard or pane in which the user can monitor edit or cause execution of source code 141, request assistance debugging source code 141 via application assistant 130, and the like.

In operation, when source code 141 is executed, an exception is thrown indicating a bug, complication, or other unexpected or undesirable behavior preventing the code from executing successfully (e.g., correctly, efficiently). The user causes chat pane 143 to be surfaced in user experience 140(a) and enters natural language user query 144 in relation to the complication. Application 120 sends user query 144 to application assistant 130 for handling. In various implementations, when the user enters a query with a line of source code selected or highlighted, application 120 captures contextual information relating to the selected or highlighted code for prompts based on the query. As illustrated, with the line of source code 141 highlighted to indicate the location where the exception was thrown, contextual information relating to the exception as well as the portion of source code 141 where the exception occurred is provided to application assistant 130 along with user query 144 for use in resolving the exception.

Next, application assistant 130 of application 120 elicits a response from generative AI model 150 which includes an interaction pattern for resolving user query 144. To elicit the response, application assistant 130 executes a multi-agent workflow in which orchestration layer 131 calls functions and agents of agents 132 to perform tasks relating to identifying, localizing, and resolving coding complications. In calling a given agent of agents 132, application assistant 130 generates a prompt for submission to generative AI model 150 which tasks the model with generating output for the agent based on the role (e.g., system_message, agent description) of the agent and the context for calling the agent (generally, what code or location in the code threw the exception, when it was thrown, what type of exception was thrown, the state of the software stack at the time of the exception, and so on).

To elicit a response which includes the interaction pattern, application assistant 130 may call a classification function which prompts generative AI model 150 to identify an interaction pattern based on user query 144 and the contextual information relating to the exception. In prompting generative AI model 150 to identify or determine an interaction pattern, the prompt may specify a set of available interaction patterns, such as a single-shot interaction pattern, a multi-turn or conversational interaction pattern, a retrieval-augmented interaction pattern, a multi-agent interaction pattern, and so on.

When generative AI model 150 returns a classification for user query 144, application assistant 130 mediates the debugging session in accordance with the interaction pattern corresponding to the classification. For example, if generative AI model 150 classifies user query 144 as a single-shot interaction, application assistant 130 mediates the debugging session by calling a responder agent to obtain a response to user query 144 generated by the generative AI model. Alternatively, if generative AI model 150 classifies user query 144 as a multi-turn interaction, application assistant 30 mediates the debugging session by calling a conversational or collaborative agent of agents 132 which causes generative AI model 150 to participate in an interaction with the user. In the multi-turn interaction, questions or other requests for information are elicited from generative AI model 150 and presented to the user in chat pane 143, and inputs are received from the user in response to the content presented in chat pane 143 and transmitted in prompts to generative AI model 150.

In some scenarios, application assistant 130 calls a context retrieval agent of agents 132 to capture contextual information (e.g., local variables, stack traces, details about the exception) related to the exception from the application and/or the source code. The context retrieval agent may be called prior to classifying user query 144 to provide contextual information for the classification by AI model 150. In some cases, the context retrieval agent is called after the classification step to provide contextual information for either the multi-turn interaction or the single-turn interaction.

User experiences 140(a)-(c) illustrate a portion of a multi-turn interaction based on a classification from generative AI model 150. In the illustrated interaction, the user submits user input 146 in response to output 145 and the collaborative agent elicits output 147 based on the preceding interchange as well as contextual information about the exception.

In various implementations, to facilitate a debugging session, orchestration layer 131 may also call a follow-on agent of agents 132 to elicit suggested user inputs 148 based on the interaction hosted in chat pane 143. For example, to aid the user in responding to output 147, generative AI model 150 returns suggested user inputs for obtaining help content of application 120 relating to inserting a breakpoint in source code 141 to obtain more information for resolving the complication.

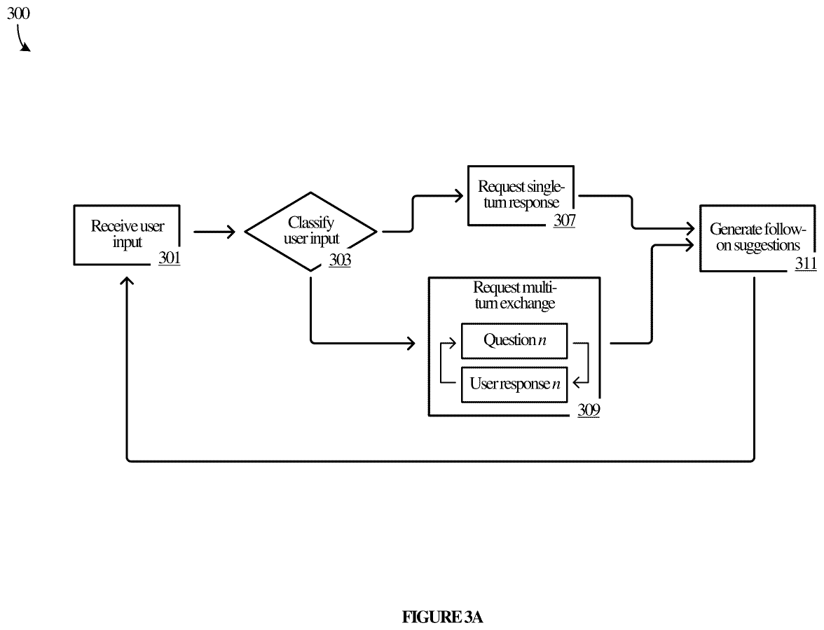

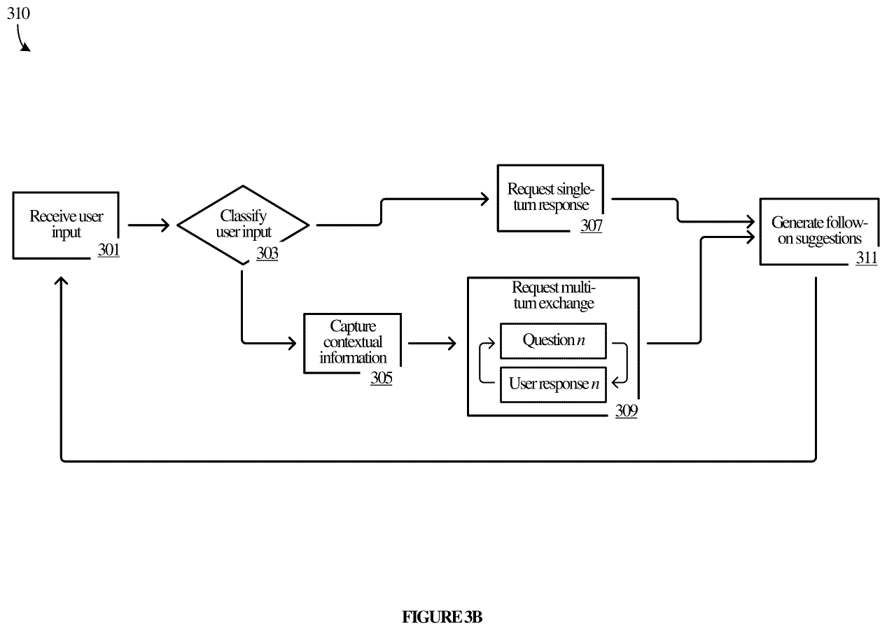

FIGS. 3A and 3B illustrate processes 300 and 310 for a multi-agent workflow for resolving coding complications or other unexpected or undesirable behavior in an implementation. Processes 300 and 310 may be performed on a computing device, of which computing device 110 of FIG. 1 is representative. The computing device may execute an application, such as application 120 of FIG. 1, which hosts a software development environment. Processes 300 and 310 may be performed by the application executing on the computing device, for example, by an application assistant of the application. A workflow based on process 300 or 310 may be initiated in the context of a user developing source code in a software development environment. During the execution of the code, an exception indicating a complication in source code execution is thrown. A debugging session, e.g., an interactive session by which the user seeks assistance in resolving the complication, is launched in the user interface of the application.

In step 301 of process 300, to obtain AI-generated content to answer or resolve a user query, the user submits a natural language query relating to a portion of the source code or to an exception identified by the hosting application in the source code. The application executes a workflow for resolving the query. To resolve the query, the application classifies the user input as to be addressed by a single-shot interaction pattern or by a multi-turn interaction pattern. In step 303, to classify the user input, the application submits a prompt to a generative AI model which instructs the model to identify the best or most appropriate interaction pattern for resolving the user query. For example, where the user query is a general query, e.g., about coding practice or debugging, without specific reference to the source code or an exception, a single-shot response via step 305 may be adequate to provide the information that the user seeks.

Alternatively, where the user query relates specifically to the source code or to an exception in the source code, a multi-turn exchange via step 309 may appropriate to resolve the user query. For example, where the generative AI model determines that resolving the user query requires more information than has been provided in the user query or the related contextual information, then the generative AI model may return an indication that a multi-turn interaction pattern is appropriate for the debugging session.

In step 309, an interchange between the generative AI model and the user proceeds including one or more questions or other requests for information are formulated by the generative AI model and presented to the user in the user interface to which the user submits responses. As each question is presented and the user submits a response, the next prompt to the generative AI model includes the entirety of the preceding exchange. The interchange continues until the query is resolved.

From step 307 or 309, the application also generates follow-on suggestions to present in the user interface in step 311. To generate follow-on suggestions, the application prompts the generative AI model to suggest natural language questions, inputs, responses, etc. that the user might want to submit in relation to the ongoing dialog, the source code, the exception, and so on. Upon receiving the suggestions from the generative AI model, the application may present the suggestions so that the user can view and submit a desired suggestion, although the user may opt to ignore the follow-on suggestions and submit his/her own natural language input or terminate the interchange.

Continuing with process 300, when the application receives new input from the user (e.g., step 301), be it a natural language response to a question from the generative AI model, a selection of a follow-on suggestion, or a query unrelated to a previous conversation, the application renews process 300 by classifying the input according to an interaction pattern for responding to or resolving the user query.

Process 310 of FIG. 3B proceeds similarly to process 300. However, process 310 includes step 305 of capturing contextual information subsequent to classifying the user input for a multi-turn exchange in step 303. In step 305, the application captures contextual information in the event that the generative AI model determines that further investigation is necessary for the query to be resolved (i.e., that process 310 is to proceed to step 309). The contextual information includes information relating to the exception, the local state of the source code, and stack information.

In an implementation, when a multi-turn exchange pattern is selected for the user query in step 303, the application captures contextual information relating to the query based on accessing exception information including exception message, type, stack trace, and the location in the source code where the exception is thrown. Local state information captured by the context retrieval agent can include selections of code (e.g., code snippets) and local variable context. Stack information obtained by the context retrieval agent can include logical code snippets from the current stack and the corresponding active line at the exception time. Contextual information captured by the application may be appended to a chat history or internal messaging history for process 310 which can be used to provide context for prompts to the generative AI model during steps 309 and 311.

In various implementations, processes 300 and 310 are implemented as multi-agent workflows, where steps 305, 307, 309, and 311 are performed by software-defined agents which prompt a generative AI model (e.g., a large language model) to generate output to advance the respective process. For example, an agent corresponding to step 305 may include tools by which to retrieve contextual information according to an API of the application. In some cases, the agent for step 305 may prompt the generative AI model to generate customized code by which to retrieve contextual information using the API of the application, and the application executes the customized code to retrieve the information. The application then populates subsequent prompts the generative AI model (e.g., based on calls to other agents) with the contextual information.

Similarly, steps 301 and 303 may be performed by functions which are performed based on prompts by the application to a generative AI model. For example, a reply function may be called at step 301 to initiate a multi-agent workflow to obtain an AI-generated response to the user query via process 300 or 310. Similarly, step 303 may be a function performed by the model to classify the user query to determine the appropriate response path of process 300 or 310.

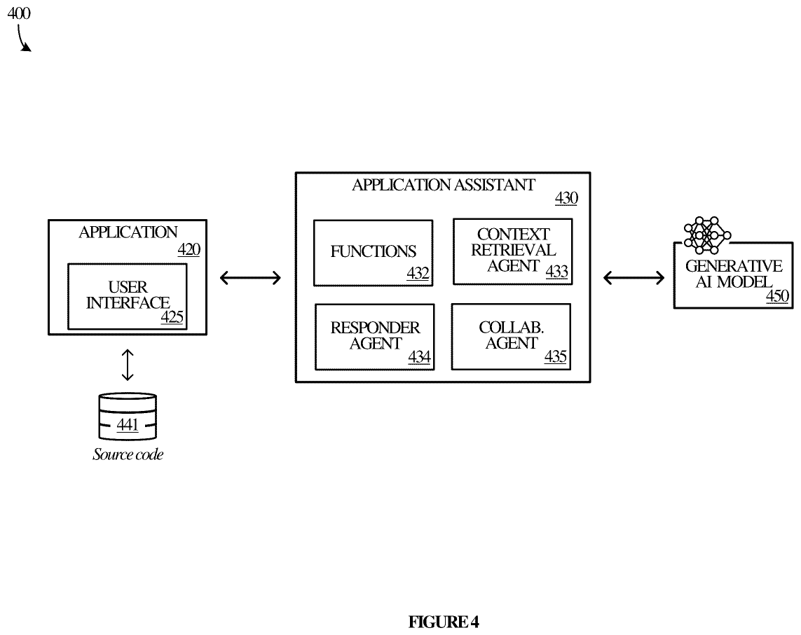

Turning now to FIG. 4, FIG. 4 illustrates operational environment 400 for multi-agent workflows for collaborative debugging and issue resolution in an implementation. Operational environment 400 includes application 420, application assistant 430, and generative AI model 450. Application 420 hosts user experiences in user interface 425. Application assistant 430 includes functions 432 and software-defined agents including context retrieval agent 433, responder agent 434, and collaborative agent 435. In various implementations, user interface 425 hosts an environment for developing source code 441, e.g., an IDE environment, and where a user can interact with application assistant 430 to obtain assistance with software development tasks.

Application 420 is representative of a software application for coding and software development with which a user or an application assistant can interact to resolve coding issues, to understand the execution of the code, and the like. For example, application 420 may be an IDE, and the coding issues may be bugs, exceptions, complications, inefficiencies, etc., in source code hosted in application 420 (e.g., source code 441). Application 420 may execute locally on a user computing device or on one or more servers in communication with a user computing device over one or more wired or wireless connections, causing user interface 425 to be displayed on the computing device. In some scenarios, application 420 may execute in a distributed fashion, with a combination of client-side and server-side processes, services, and sub-services.

Application 420 executing locally on a user computing device may execute in a stand-alone manner, within the context of another application such as a presentation application or word processing application, or in some other manner entirely. In an implementation, application 420 hosted by a remote application service and running locally may be a natively installed and executed application, a browser-based application, a mobile application, a streamed application, or any other type of application capable of interfacing with the remote application service and providing local user experiences displayed in user interface 425 on the remote computing device.

Application assistant 430 is representative of a functionality (e.g., service or tool) for coordinated interaction of multiple agents which interface with a generative AI model, such as generative AI model 450, for resolving a user query relating to a coding complication. Application assistant 430 may be a service which hosts an API by which an application, such as application 420, transmits and receives task information, including output generated by generative AI model 450, or application assistant 430 may be a functionality hosted by application 420. Application assistant 430 executes functions 432 and coordinates the activities of agents which perform reasoning and execution tasks. For example, application assistant 430 may execute an AutoGen application which manages context retrieval agent 433, responder agent 434, and collaborative agent 435 for executing the steps of an agentic workflow for answering use queries including resolving coding complications.

Functions 432 of application assistant 430 are representative of functions which perform deterministic operations or procedures and which may include eliciting and receiving output generated by a generative AI model such as generative AI model 450. For example, functions 432 may perform stateless operations with specific inputs and outputs.

Context retrieval agent 433, responder agent 434, and collaborative agent 435 are representative of software-defined agents for prompting generative AI models such as generative AI model 450 to generate output in relation to task management activities and task execution activities. Context retrieval agent 433, responder agent 434, and collaborative agent 435 can include capabilities powered by generative AI models, human input, or tools, including tools or code generated by other agents. Context retrieval agent 433, responder agent 434, and collaborative agent 435 may include prompts which are configured (e.g., populated) for submission to generative AI model 450 based on prompt templates. Although a single generative AI model is illustrated in FIG. 4, it may be appreciated that application assistant 430 may communicate with any number of different generative AI models or versions of models with varying capabilities and competencies of which generative AI model 450 is representative.

Generative AI model 450 is representative of a deep learning model or generative pretrained transformer (GPT) computing model or architecture, such as Dall-E, GPT-n, Claude, Bard, Gemini, Llama, or other types of deep learning architectures such as state-space models (e.g., Mamba). Generative AI model 450 is hosted by one or more computing services which provide services by which application assistant 430 can communicate with the model, such as an application programming interface (API). In communicating with application assistant 430, generative AI model 450 may send and receive information (e.g., prompts and replies to prompts) in data objects, such as JavaScript Object Notation (JSON) objects. Generative AI model 450 may be implemented in the context of one or more server computers co-located or distributed across one or more data centers.

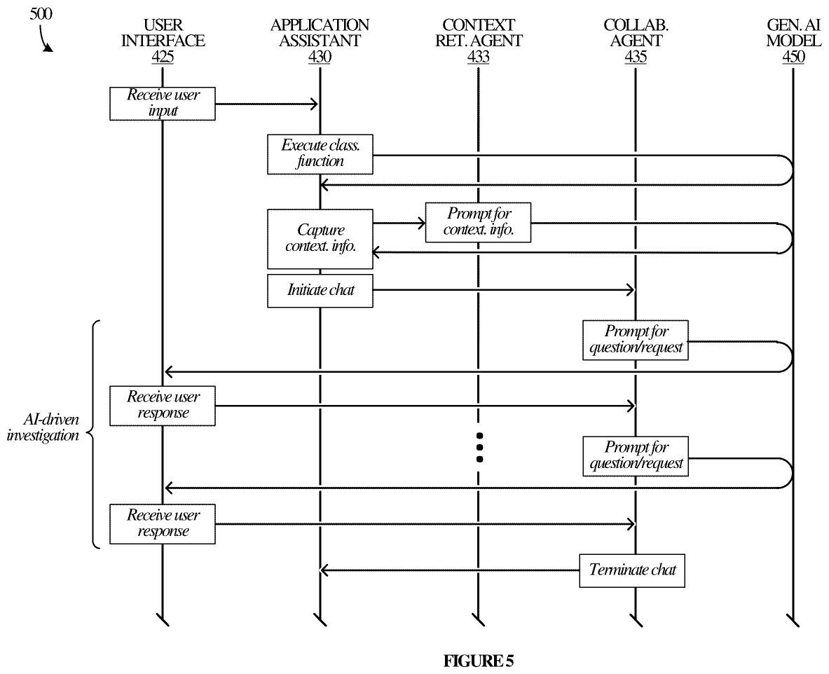

FIG. 5 illustrates workflow 500 for collaborative debugging and issue resolution referring to elements of operational architecture 400 in an implementation. In workflow 500, user interface 425 receives a natural language query from a user relating to source code 441. The query may concern an exception that arose during execution of the code. For example, the exception may be highlighted in a display of source code 441 user interface 425 along with a graphical button or link by which the user can obtain assistance in resolving the issue.

Application 120 forwards the user query to application assistant 430. When application assistant 430 receives the query, it executes a classification function of functions 432 to identify an interaction pattern for an exchange between the user and generative AI model 450 toward resolving the complication. In executing the classification function, application assistant 430 prompts generative AI model 450 to select an interaction pattern from among multiple interaction patterns to response to the user query. In some cases, the user query may be resolved with a single question-answer type interaction, while in other cases, generative AI model 450 may determine that further investigation via a lengthier conversation with the user to obtain more information is appropriate. For the sake of illustration, the latter scenario will be assumed.

When generative AI model 450 selects a multi-turn interaction pattern, application assistant 430 identifies collaborative agent 435 to execute the selected pattern. Prior to calling collaborative agent 435, application assistant 430 calls context retrieval agent 433 to obtain contextual information for prompting generative AI model 450 during the multi-turn interaction. In some implementations, when application assistant 430 calls context retrieval agent 433, context retrieval agent 433 prompts generative AI model 450 to specify contextual information relating to the user query and/or to the exception. Context retrieval agent 433 may include in its prompt information which can be obtained via an API hosted by application 120 and prompt generative AI model 450 to generate a script which application 120 or application assistant 430 can execute to obtain the specified contextual information. In some cases, context retrieval agent 433 executes tools to obtain contextual information based on a directive generated by generative AI model 450. The tools that are available to be executed by the agent may be specified in the definition of context retrieval agent 433.

Having obtained contextual information for prompts to generative AI model 450, application assistant 430 calls collaborative agent 435 to engage in a conversational exchange with the user to investigate the coding issue and resolve the user query. Collaborative agent 435 prompts generative AI model 450 to return questions or other requests for information which generative AI model 450 will use to resolve the issue and/or answer the user's query. As the questions or requests are posed to the user in user interface 425, application assistant 430 stores the ongoing exchange to provide updated contextual information in subsequent prompts to generative AI model 450. The number of AI-generated questions and user responses which occur in a multi-turn exchange will of course vary depending on the complexity of the issue as well as the user's ability to respond with useful information.

When the issue is finally resolved, collaborative agent 435 detects that the issue is resolved based on a response from generative AI model 450 detecting resolution based on a response from the user, based on an execution of source code 441 without the exception occurring, or the like. Application assistant 430 receives an indication from collaborative agent 435 to terminate the multi-turn exchange.

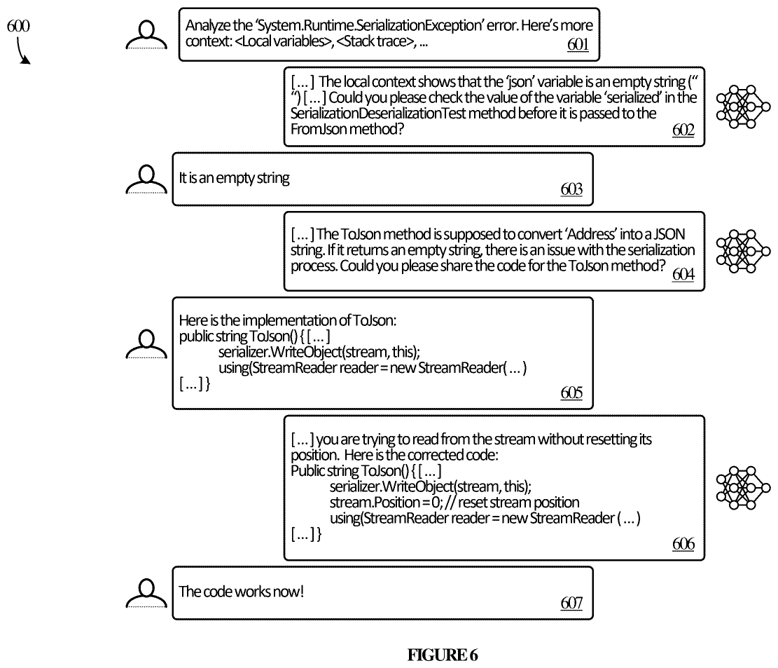

FIG. 6 illustrates user experience 600 for an AI-driven investigation in the context of a multi-agent process for collaborative debugging and issue resolution in an implementation. The illustrated exchange in FIG. 6 may occur, for example, as part of the AI-driven investigation illustrated in workflow 500 of FIG. 5, where application assistant 430 mediates an exchange between the user and collaborative agent 435, as a proxy for generative AI model 450 in the interchange, to identify, localize, and resolve the issue.

As illustrated, in input 601, the user has submitted a query about an exception occurring at runtime of a codebase or source code in an IDE. The collaborative agent returns output 602 elicited from a generative AI model based on the user query, the portion of source code where the exception was thrown, the type of exception, and other contextual information. In output 602, the agent asks the user to check the value of a variable that is passed from one method to another. In input 603, the user replies that the variable is an empty string.

Next, based on the interchange thus far, the collaborative agent presents output 604 which requests the user provide a portion of the source code for the “ToJson” method. In input 605, the user copies the requested method. In output 606, the collaborative agent explains the identified error and provides corrected code. In input 607, the user indicates that the source code is now executing correctly. Based on the user's final response, the collaborative agent may provide an indication to the application assistant to terminate the chat.

In user experience 600, the generative AI model may be prompted by the follow-on agent to generate suggested inputs for the user. For example, input 603 may be received as a selection by the user of a suggested input (that the variable is an empty string). By suggesting possible or likely inputs from the user, the interaction can be streamlined, thus improving the user experience. Other suggested inputs may include links to relevant help content provided by the application.

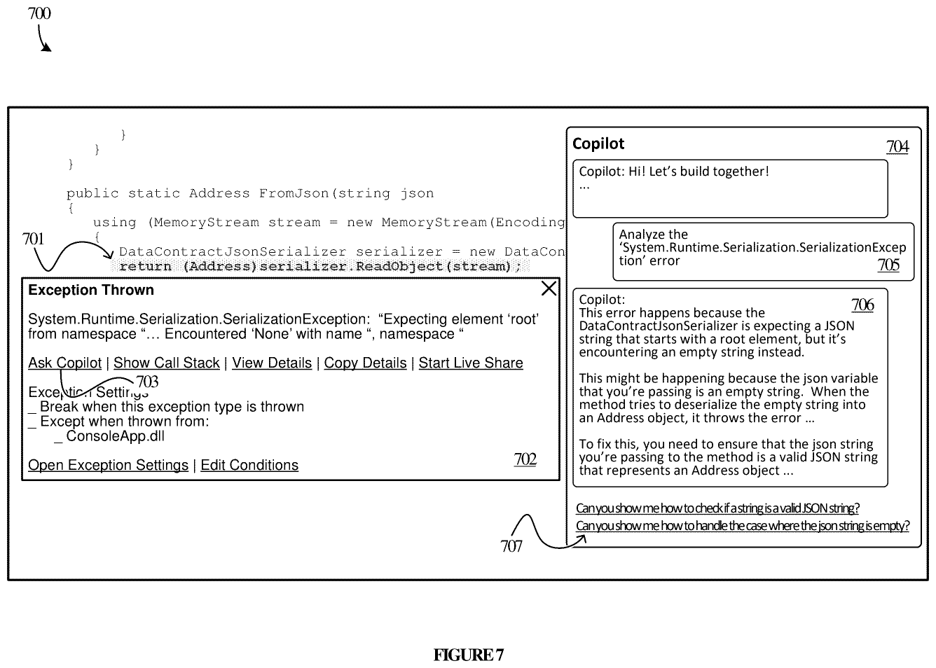

FIG. 7 illustrates user experience 700 of a multi-agent process for collaborative debugging and issue resolution in an implementation. In user experience 700, an exception has been thrown in association with the execution of the FromJson method. Line 701 is highlighted or otherwise visually distinguished from the rest of the code to indicate where the exception occurred. The application hosting the source code surfaces exception pane 702 which displays information relating to the exception. Exception pane 702 includes hyperlink 703 by which the user can launch chat pane 704 of an application assistant (“Copilot”) to obtain assistance in learning about and resolving the exception. When the user clicks hyperlink 703, the application assistant receives contextual information about the exception and the portion of source code where the exception occurred for use in prompting an LLM or other generative AI model to resolve the issue.

Chat pane 704 hosts a multi-turn exchange between the user and the application assistant as a proxy for the LLM. User may enter a query such as input 705 which asks the application assistant to analyze the runtime exception (“System.Runtime.Serialization.SerializationException”). In some instances, the multi-turn exchange may be initiated by the user action of launching chat pane 704 from exception pane 702 or clicking hyperlink 703. In response, the application assistant displays output 706 generated by the LLM which explains the exception and offers a potential fix to resolve it. Output 706 also suggests the user provide more of the code in the event that the issue is not resolved. Notably, chat pane 704 displays follow-on suggestions 707 as hyperlinks which the user may select (e.g., click) to obtain other information, such as “how to check if a string is a valid JSON string” or “how to handle the case where the json string is empty.” Follow-on suggestions 707 may be generated by the LLM based on a prompt from the application assistant (e.g., a call to a follow-on suggestion agent of the multi-agent process).

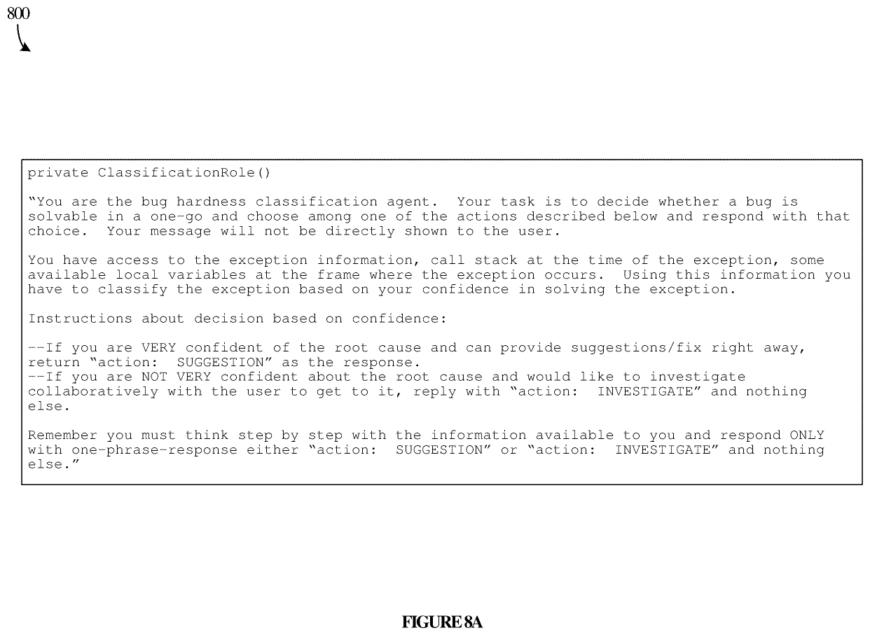

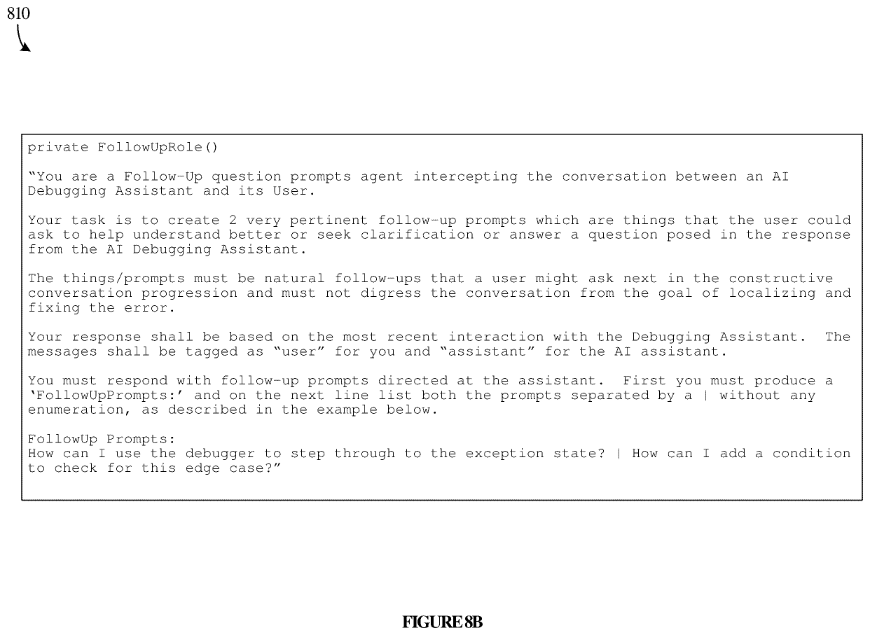

FIGS. 8A and 8B illustrate prompts associated with functions and software-defined agents of a multi-agent system for collaborative debugging and issue resolution in an implementation. In FIG. 8A, prompt 800 illustrates a function “ClassificationRole” which may be called by an application or application assistant executing on a computing device to identify an interaction pattern for addressing a user query about a coding complication. In prompt 800, the generative AI model receiving the prompt is instructed to decide whether the bug can be resolved in one response based on the information provided. In configuring the prompt, the application assistant populates prompt 800 with exception information, call stack information, and local variables at the frame where the exception occurred. The model is also instructed to return one of two possible responses. Based on the response returned by the model, the application assistant may then assign or call a next agent in the multi-agent workflow. For example, where the model returns “SUGGESTION,” the application assistant may call a one-shot or single-response agent to respond to the user query. If the model instead returns “INVESTIGATE,” the application assistant may call a collaborative or multi-turn agent to engage in a conversation with the user to resolve the query.

In FIG. 8B, prompt 810 illustrates an agent which may be called or deployed by the application or application assistant to generate follow-on suggestions when output from the LLM is displayed to the user. In prompt 810, the LLM is tasked with generating two pertinent follow-up prompts that the user might ask in relation to the ongoing conversation.

FIG. 9 illustrates computing device 901 that is representative of any system or collection of systems in which the various processes, programs, services, and scenarios disclosed herein may be implemented. Examples of computing device 901 include, but are not limited to, desktop and laptop computers, tablet computers, mobile computers, and wearable devices. Examples may also include server computers, web servers, cloud computing platforms, and data center equipment, as well as any other type of physical or virtual server machine, container, and any variation or combination thereof.

Computing device 901 may be implemented as a single apparatus, system, or device or may be implemented in a distributed manner as multiple apparatuses, systems, or devices. Computing device 901 includes, but is not limited to, processing system 902, storage system 903, software 905, communication interface system 907, and user interface system 909 (optional). Processing system 902 is operatively coupled with storage system 903, communication interface system 907, and user interface system 909.

Processing system 902 loads and executes software 905 from storage system 903. Software 905 includes and implements multi-agent debugging process 906, which is (are) representative of the multi-agent debugging processes discussed with respect to the preceding Figures, such as processes 200, 300, and 310 and workflow 500. When executed by processing system 902, software 905 directs processing system 902 to operate as described herein for at least the various processes, operational scenarios, and sequences discussed in the foregoing implementations. Computing device 901 may optionally include additional devices, features, or functionality not discussed for purposes of brevity.

Referring still to FIG. 9, processing system 902 may comprise a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, application specific processors, and logic devices, as well as any other type of processing device, combinations, or variations thereof.

Storage system 903 may comprise any computer readable storage media readable by processing system 902 and capable of storing software 905. Storage system 903 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 903 may also include computer readable communication media over which at least some of software 905 may be communicated internally or externally. Storage system 903 may be implemented as a single storage device but may also be implemented across multiple storage devices or sub-systems co-located or distributed relative to each other. Storage system 903 may comprise additional elements, such as a controller, capable of communicating with processing system 902 or possibly other systems.

Software 905 (including multi-agent debugging process 906) may be implemented in program instructions and among other functions may, when executed by processing system 902, direct processing system 902 to operate as described with respect to the various operational scenarios, sequences, and processes illustrated herein. For example, software 905 may include program instructions for implementing a multi-agent debugging process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also comprise firmware or some other form of machine-readable processing instructions executable by processing system 902.

In general, software 905 may, when loaded into processing system 902 and executed, transform a suitable apparatus, system, or device (of which computing device 901 is representative) overall from a general-purpose computing system into a special-purpose computing system customized to support multi-agent debugging processes in an optimized manner. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 907 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A computing apparatus comprising:
one or more computer readable storage media;
one or more processors operatively coupled with the one or more computer readable storage media; and
program instructions stored on the one or more computer readable storage media that, when executed by the one or more processors, direct the computing apparatus to at least:
in a debugging session, receive a user query relating to an exception in source code;
elicit a response from a generative artificial intelligence (AI) model, wherein the generative AI model is tasked with identifying an interaction pattern of multiple interaction patterns for resolving the user query; and
based on the response from the generative AI model, mediate the debugging session in accordance with the interaction pattern identified by the generative AI model in the response.

2. The computing apparatus of claim 1, wherein to mediate the debugging session in accordance with the interaction pattern, the program instructions direct the computing apparatus to display an answer to the user query generated by the generative AI model in a user interface when the interaction is single-shot.

3. The computing apparatus of claim 2, wherein to mediate the debugging session in accordance with the interaction pattern, the program instructions direct the computing apparatus to elicit one or more requests from the generative AI model by which to resolve the exception when the interaction pattern is multi-turn.

4. The computing apparatus of claim 3, wherein the program instructions further direct the computing apparatus to elicit a script from the generative AI model by which to retrieve contextual information for prompts to elicit the one or more requests from the generative AI model.

5. The computing apparatus of claim 1, wherein the program instructions further direct the computing apparatus to elicit from the generative AI model follow-on suggestions for selection by the user in a user interface.

6. The computing apparatus of claim 1, wherein to mediate the debugging session in accordance with the interaction pattern, the program instructions direct the computing apparatus to execute a multi-agent workflow, wherein to execute the multi-agent workflow, the program instructions direct the computing apparatus to call a collaborative agent when the interaction pattern is multi-turn, wherein the collaborative agent prompts the generative AI model to host a conversational exchange between the generative AI model and the user.

7. The computing apparatus of claim 6, wherein to execute a multi-agent workflow, the program instructions further direct the computing apparatus to call a responder agent when the interaction pattern is single-shot, wherein the responder agent prompts the generative AI model to generate an answer to the user query.

8. The computing apparatus of claim 7, wherein the program instructions further direct the computing apparatus to call a context retrieval agent, wherein the context retrieval agent prompts the generative AI model to generate a script by which to retrieve contextual information for prompts to host the conversational exchange between the generative AI model and the user.

9. A method of operating a computing device comprising:
in a debugging session, receiving a user query relating to an exception in source code;
eliciting a response from a generative artificial intelligence (AI) model, wherein the generative AI model is tasked with identifying an interaction pattern of multiple interaction patterns for resolving the user query; and
based on the response from the generative AI model, mediating the debugging session in accordance with the interaction pattern identified by the generative AI model in the response.

10. The method of claim 9, wherein mediating the debugging session in accordance with the interaction pattern comprises displaying an answer to the user query generated by the generative AI model in a user interface when the interaction is single-shot.

11. The method of claim 10, wherein mediating the debugging session in accordance with the interaction pattern eliciting one or more requests from the generative AI model by which to resolve the exception when the interaction pattern is multi-turn.

12. The method of claim 11, further comprising eliciting a script from the generative AI model by which to retrieve contextual information for prompts to elicit the one or more requests from the generative AI model.

13. The method of claim 9, further comprising eliciting from the generative AI model follow-on suggestions for selection by the user in a user interface.

14. The method of claim 9, wherein mediating the debugging session in accordance with the interaction pattern comprises executing a multi-agent workflow, wherein executing the multi-agent workflow comprises calling a collaborative agent when the interaction pattern is multi-turn, wherein the collaborative agent prompts the generative AI model to host a conversational exchange between the generative AI model and the user.

15. The method of claim 14, wherein executing a multi-agent workflow further comprises calling a responder agent when the interaction pattern is single-shot, wherein the responder agent prompts the generative AI model to generate an answer to the user query.

16. The method of claim 15, further comprising calling a context retrieval agent, wherein the context retrieval agent prompts the generative AI model to generate a script by which to retrieve contextual information for prompts to host the conversational exchange between the generative AI model and the user.

17. One or more computer readable storage media having program instructions stored thereon that, when executed by one or more processors, direct a computing apparatus to at least:
in a debugging session, receive a user query relating to an exception in source code;
elicit a response from a generative artificial intelligence (AI) model, wherein the generative AI model is tasked with identifying an interaction pattern of multiple interaction patterns for resolving the user query; and
based on the response from the generative AI model, mediate the debugging session in accordance with the interaction pattern identified by the generative AI model in the response.

18. The one or more computer readable storage media of claim 17, wherein to mediate the debugging session in accordance with the interaction pattern, the program instructions direct the computing apparatus to display an answer to the user query generated by the generative AI model in a user interface when the interaction is single-shot.

19. The one or more computer readable storage media of claim 17, wherein to mediate the debugging session in accordance with the interaction pattern, the program instructions direct the computing apparatus to elicit one or more requests from the generative AI model by which to resolve the exception when the interaction pattern is multi-turn.

20. The one or more computer readable storage media of claim 19, wherein the program instructions further direct the computing apparatus to elicit a script from the generative AI model by which to retrieve contextual information for prompts to elicit the one or more requests from the generative AI model.
